(19) United States
(12) Patent Application Publication
(10) Pub. No.: US 2026/0172231 A1
(43) Pub. Date: Jun. 18, 2026

(54) FIDO DEVICE ONBOARDING SYSTEM AND METHOD FOR AIR-GAPPED ENVIRONMENTS

(71) Applicant: Dell Products L.P., Round Rock, TX (US)

(72) Inventors: Xingyu Wang, Singapore (SG); Nyi Nyi Thwin, Singapore (SG); Jia Yuan Chia, Singapore (SG)

(73) Assignee: Dell Products L.P., Round Rock, TX (US)

(21) Appl. No.: 18/984,020

(22) Filed: Dec. 17, 2024

(51) Int. Cl. H04L 9/08; H04L 67/10

(52) U.S. Cl. CPC H04L 9/0825; H04L 67/10

(57) ABSTRACT

According to embodiments of the present disclosure, a FIDO device onboarding system and method for air-gapped environments is provided in which a first ECE is provided with EO functionality so that it can onboard ensuing ECEs into the air-gapped environment. According to one embodiment, a Fast ID Online (FIDO) device onboarding system includes a first Edge Compute Endpoint (ECE) that conforms to a FIDO Device Onboard (FDO) standard, the first ECE includes executable code to assign the first ECE to be a local owner in an air-gapped environment, receive an extended ownership voucher associated with a second ECE, and using the extended ownership voucher, onboard the second ECE to the first ECE. The extended ownership voucher is signed by a public key of the first ECE.

### BACKGROUND

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware and software components that may be configured to process, store, and communicate information and may include one or more computer systems, data storage systems, and networking systems.

Security has become an important aspect of the IHSs operation as bad actors continually develop new ways to illicitly intrude into IHSs. For each IHS architectural makeup, several potential points of attack may exist for a malicious party to steal data, modify data, and/or engage in other illicit activities. To mitigate the potential for such attacks, a variety of techniques may be employed to enhance the security of IHSs. For example, secure communication channels between the various components of an IHS may be established, such as those using Transport Layer Security (TLS) and/or Secure Sockets Layer (SSL) protocols. As another example, password and/or other credential-based authentication between the various components of an IHS may be used to establish trust. In yet another example, non-password secure communication techniques that do not necessarily require user input may be applied. In such cases, to enable non-password administrative addressing to an endpoint, an authentication technique, such as a Fast ID Online (FIDO) protocol may be used to further protect endpoint secrets with certain cryptographic methods. The FIDO Device Onboard (FDO) standard may use the FIDO protocol to automate an initial registration operation of a device using a Rendezvous (RV) server.

### SUMMARY

According to embodiments of the present disclosure, a FIDO device onboarding system and method for air-gapped environments is provided in which a first ECE is provided with EO functionality so that it can onboard ensuing ECEs into the air-gapped environment. According to one embodiment, a Fast ID Online (FIDO) device onboarding system includes a first Edge Compute Endpoint (ECE) that conforms to a FIDO Device Onboard (FDO) standard, the first ECE includes executable code to assign the first ECE to be a local owner in an air-gapped environment, receive an extended ownership voucher associated with a second ECE, and using the extended ownership voucher, onboard the second ECE to the first ECE. The extended ownership voucher is signed by a public key of the first ECE.

According to another embodiment, a FIDO device onboarding method includes the steps of assigning, using a first Edge Compute Endpoint (ECE) that conforms to a Fast ID Online (FIDO) Device Onboard (FDO) standard, the first ECE to be a local owner in an air-gapped environment, receiving an extended ownership voucher associated with a second ECE, wherein the extended ownership voucher is signed by a public key of the first ECE, and using the extended ownership voucher, onboarding the second ECE to the first ECE.

According to yet another embodiment, a computer program product comprising a non-transitory computer readable storage medium has program instructions stored thereon that, upon execution by an Information Handling System (IHS), cause the IHS to assign, using a first Edge Compute Endpoint (ECE) that conforms to a Fast ID Online (FIDO) Device Onboard (FDO) standard, the first ECE to be a local owner in an air-gapped environment, receive an extended ownership voucher associated with a second ECE, wherein the extended ownership voucher is signed by a public key of the first ECE, and using the extended ownership voucher, onboard the second ECE to the first ECE.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 shows an example of an IHS that may be configured to implement embodiments described herein.

FIG. 2 illustrates an example FIDO device onboarding system that may be used to onboard ECEs in an air-gapped environment according to one embodiment of the present disclosure.

FIGS. 3A through 3E illustrate an example FIDO device onboarding method that may be used to onboard ECEs in an air-gapped environment according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below.

Cyber attackers are reportedly exploiting and abusing devices, such as platform interface protocol analyzers to steal unencrypted information, spy on network traffic, and gather information to leverage in future attacks against platform components and component interfaces (e.g., I2C, PCIe, I3C, Sensewire, SPI, etc.) of IHSs. Detection of vulnerable platform components is not an easy task, and exploiting unpatched vulnerabilities could allow the attacker to take control of an IHS. Some example platform security risks may include compromised security in which hostile component insertion and/or compromised firmware updates can cause supply chain security issues. Another example platform security risk may include confidentiality and integrity risks in which data transfers that are unencrypted may be vulnerable to eavesdropping, stealing, and tampering. Additionally, non-compliant security configuration errors, certificate management, platform security trust, and the like could lead to non-compliance with industry standard security policies. The FIDO Device Onboard (FDO) standard has been developed to alleviate such problems and reduce management overhead in maintaining and establishing the platform security involving non-password secure communication techniques within the IHS infrastructure domain.

Fast Identity Online (FIDO) provides users with passwordless authentication using security keys. Passwordless authentication systems allow users to authenticate an edge compute endpoint (ECE) rather than a password and assert their identity with a strong public key credential rather than a shared secret, that is, a password. The credentials belong to the user and are managed by an edge orchestrator (EO), with which the relying party application interacts through the FIDO platform. Additionally, the FIDO Device Onboard (FDO) standard may use the FIDO protocol to automate an initial registration operation of a device using a Rendezvous (RV) server.

The current FDO standard specifies that ECEs onboard to an EO directly. This, however, creates a limitation in an air-gapped environment in which case, either all the ECEs need to be onboarded to the EO before being shipped to the air-gapped location, or a dedicated EO, with a network, needs to be disposed at the air-gapped location. This often may create a scaling limitation when clustering is needed and when new devices need to be shipped to the location to join the clustering at an ongoing basis. As will be described in detail herein below, embodiments of the present disclosure provide a FIDO device onboarding system and method for air-gapped environments in which a first ECE is provided with EO functionality so that it can onboard ensuing ECEs into the air-gapped environment.

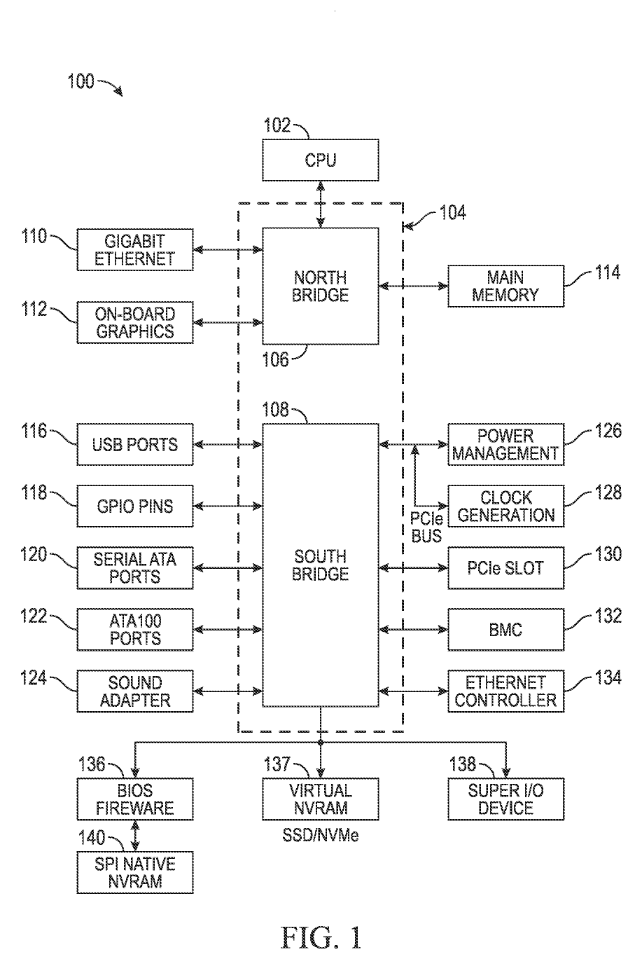

FIG. 1 shows an example of an IHS 100 that may be configured to implement embodiments described herein. It should be appreciated that although certain embodiments described herein may be discussed in the context of a desktop or server computer, other embodiments may be utilized with virtually any type of IHS 100. Particularly, the IHS 100 includes a baseboard or motherboard, to which is a printed circuit board (PCB) to which components or devices are mounted by way of a bus or other electrical communication path. For example, Central Processing Unit (CPU) 102 operates in conjunction with a chipset 104. CPU 102 is a processor that performs arithmetic and logic necessary for the operation of the IHS 100.

Chipset 104 includes northbridge 106 and southbridge 108. Northbridge 106 provides an interface between CPU 102 and the remainder of the IHS 100. Northbridge 106 also provides an interface to a random access memory (RAM) used as main memory 114 in the IHS 100 and, possibly, to on-board graphics adapter 112. Northbridge 106 may also be configured to provide networking operations through Ethernet adapter 110. Ethernet adapter 110 is capable of connecting the IHS 100 to another IHS 100 (e.g., a remotely located IHS 100) via a network. Connections which may be made by Ethernet adapter 110 may include local area network (LAN) or wide area network (WAN) connections. Northbridge 106 is also coupled to southbridge 108.

Southbridge 108 is responsible for controlling many of the input/output (I/O) operations of the IHS 100. In particular, southbridge 108 may provide one or more universal serial bus (USB) ports 116, sound adapter 124, Ethernet controller 134, and one or more general purpose input/output (GPIO) pins 118. Southbridge 108 may also provide a bus for interfacing peripheral card devices such as PCIe slot 130. In some embodiments, the bus may include a peripheral component interconnect (PCI) bus. Southbridge 108 may also provide baseboard management controller (BMC) 132 for use in managing the various components of the IHS 100. Power management circuitry 126 and clock generation circuitry 128 may also be utilized during operation of southbridge 108.

Additionally, southbridge 108 is configured to provide one or more interfaces for connecting mass storage devices to the IHS 100. For instance, in one embodiment, southbridge 108 may include a serial advanced technology attachment (SATA) adapter for providing one or more serial ATA ports 120 and/or an ATA100 adapter for providing one or more ATA100 ports 122. Serial ATA ports 120 and ATA100 ports 122 may be, in turn, connected to one or more mass storage devices storing an operating system (OS) and application programs.

An OS may comprise a set of programs that controls operations of the IHS 100 and allocation of resources. An application program is software that runs on top of the OS and uses computer resources made available through the OS to perform application-specific tasks desired by the user.

Mass storage devices connected to southbridge 108 and PCIe slot 130, and their associated computer-readable media provide non-volatile storage for the IHS 100. Although the description of computer-readable media contained herein refers to a mass storage device, such as a hard disk or CD-ROM drive, it should be appreciated by a person of ordinary skill in the art that computer-readable media can be any available media on any memory storage device that can be accessed by the IHS 100. Examples of memory storage devices include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices.

A low pin count (LPC) interface may also be provided by southbridge 108 for connecting Super I/O device 138. Super I/O device 138 is responsible for providing a number of I/O ports, including a keyboard port, a mouse port, a serial interface, a parallel port, and other types of input/output ports.

The LPC interface may connect a computer storage media such as a ROM or a flash memory such as a non-volatile random access memory (NVRAM) for storing BIOS/firmware 136 that includes BIOS program code containing the basic routines that help to start up the IHS 100 and to transfer information between elements within the IHS 100. BIOS/firmware 136 comprises firmware compatible with the Extensible Firmware Interface (EFI) Specification and Framework.

The LPC interface may also be utilized to connect virtual NVRAM 137 (e.g., SSD/NVMe) to the IHS 100. The virtual NVRAM 137 may be utilized by BIOS/firmware 136 to store configuration data for the IHS 100. In other embodiments, configuration data for the IHS 100 may be stored on the same virtual NVRAM 137 as BIOS/firmware 136. The IHS 100 may also include a SPI native NVRAM 140 coupled to the BIOS/firmware 136.

BMC 132 may include non-volatile memory having program instructions stored thereon that enable remote management of the IHS 100. For example, BMC 132 may enable a user to discover, configure, and manage the IHS 100, setup configuration options, resolve and administer hardware or software problems, etc. Additionally or alternatively, BMC 132 may include one or more firmware volumes, each volume having one or more firmware files used by the BIOS’ firmware interface to initialize and test components of the IHS 100.

As a non-limiting example of BMC 132, the integrated DELL Remote Access Controller (iDRAC) from DELL, INC. is embedded within DELL POWEREDGE servers and provides functionality that helps information technology (IT) administrators deploy, update, monitor, and maintain servers with no need for any additional software to be installed. The iDRAC works regardless of OS or hypervisor presence from a pre-OS or bare-metal state because iDRAC is embedded within the IHS 100 from the factory.

It should be appreciated that, in other embodiments, the IHS 100 may comprise other types of computing devices, including hand-held computers, embedded computer systems, personal digital assistants, and other types of computing devices. It is also contemplated that the IHS 100 may not include all of the components shown in FIG. 1, may include other components that are not explicitly shown in FIG. 1, or may utilize a different architecture.

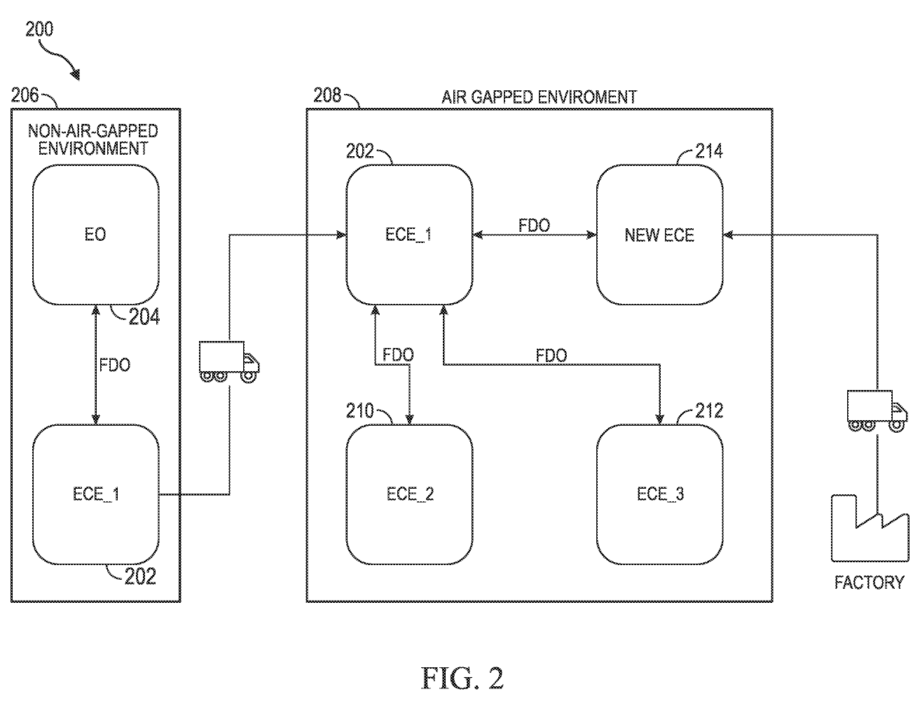

FIG. 2 illustrates an example FIDO device onboarding system 200 that may be used to onboard ECEs in an air-gapped environment according to one embodiment of the present disclosure. The FIDO device onboarding system 200 includes a first ECE 202 that is onboarded to an EO 204 in a non-air-gapped environment 206. The first ECE 202 is then shipped to, and deployed in an air-gapped environment 208. The first ECE 202 includes EO functionality so that it can onboard a second ECE 210 and a third ECE 212 without having to communicate with any entity outside of the air-gapped environment 208. Later on, if scaling is needed, a new ECE 214 can also be shipped to the air-gapped location to onboard to the first ECE 202 directly.

Within this disclosure, an air-gapped environment generally refers to one in which communication of any ECEs in the air-gapped environment are are inhibited from communicating with any other node outside of the air-gapped environment.

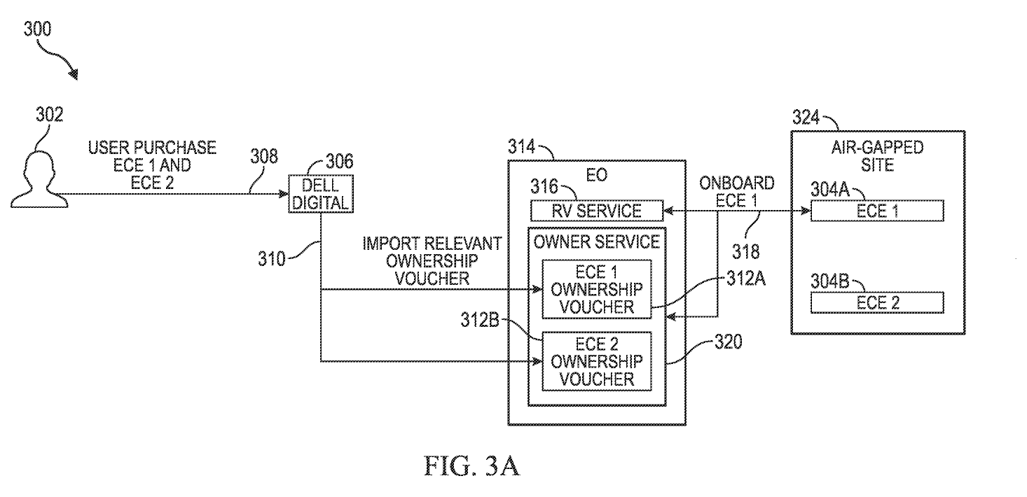

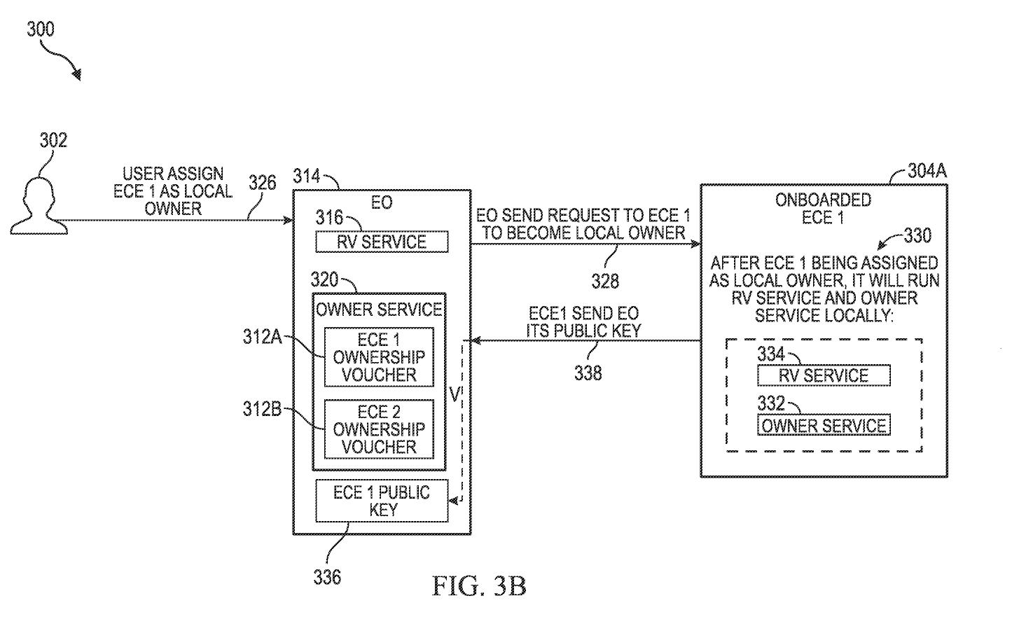

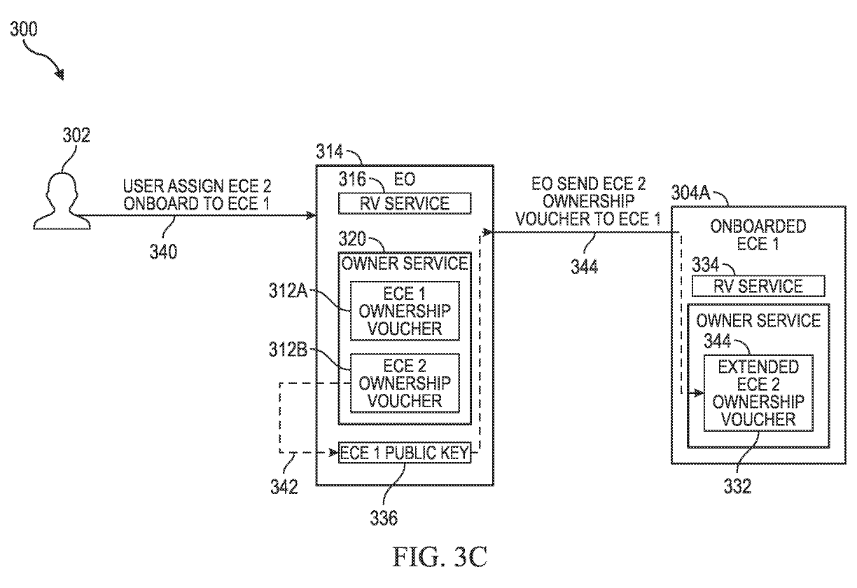

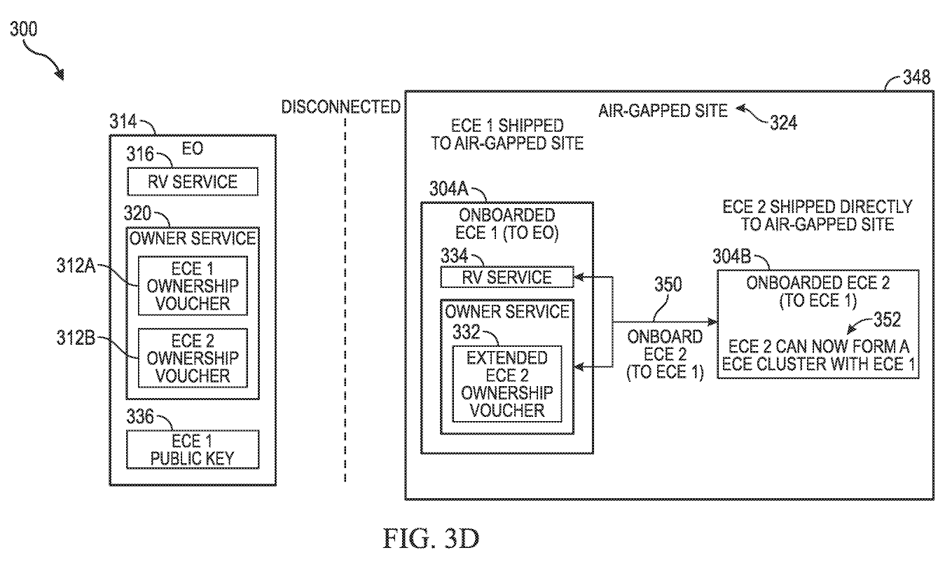

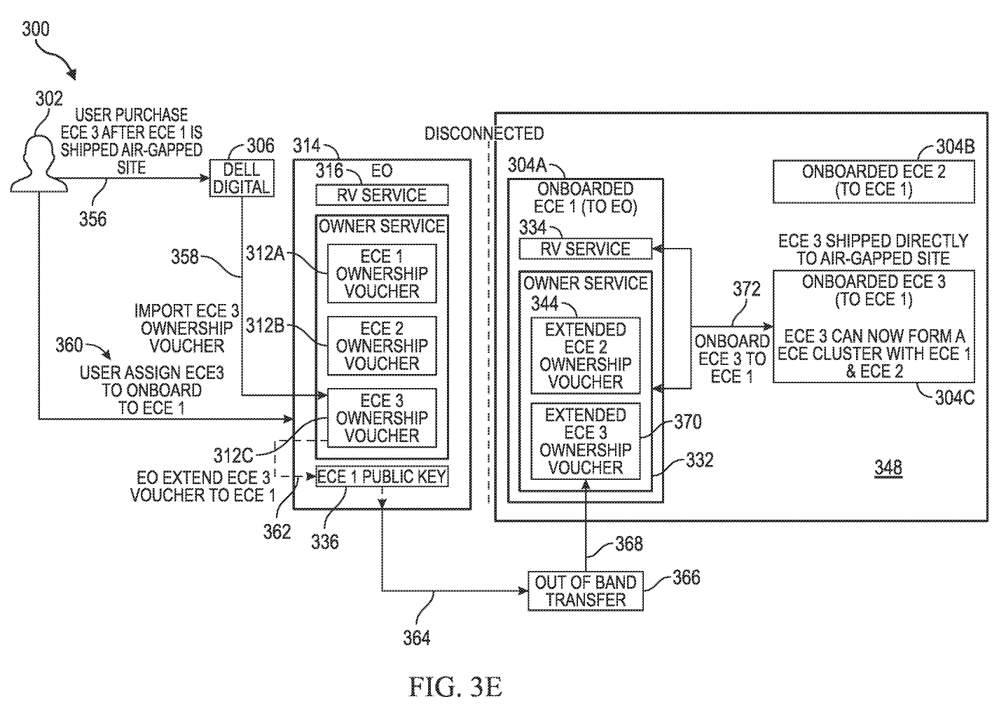

FIGS. 3A through 3E illustrate an example FIDO device onboarding method 300 that may be used to onboard ECEs in an air-gapped environment according to one embodiment of the present disclosure. With reference to FIG. 3A, a user 302 initially purchases a first ECE 304a and a second ECE 304b (collectively 304) from a vendor portal 306 at step 308. The vendor portal 306, for example, may be a website of a vendor who manufactures or otherwise provides the ECEs 304 for use by the user 302. Thereafter at step 310, ownership vouchers 312a-b (collectively 312) for both the first and second ECEs 304 are imported to a user-defined EO 314.

Both ECEs 304 are meant to operate at an air-gapped site 320 or other location where connectivity to the EO 314 is not guaranteed. The first ECE 304a is first shipped to a site where it has connectivity to the user-defined EO 314 and onboarded to the user-defined EO 314 using a rendezvous (RV) service 316 at step 318. Additionally, the ownership vouchers 312 are stored in an owner service 320 of the user-defined EO 314. Meanwhile, the second ECE 304b is directly shipped to the target air-gapped site 324.

Referring now to FIG. 3B, the user 302 authenticates the first ECE 304a as a local owner via EO 314 at step 326. Thereafter at step 328, the EO 314 sends a request to have the first ECE 304a become a local owner. As a local owner, the first ECE 304a may at step 330, be imparted with an owner service 332 and a RV service 334 that are both executed on the first ECE 304a. Moreover, the first ECE 304a will start running the local RV service 334 and owner service 332 within itself, and send its public key 336 to the EO 314 for voucher extension at step 338. The EO 314 will maintain the mapping of the first ECE 304a and its owner public key 336 for future voucher signing. At this point, the user 302 can also deploy a cluster workload to the first ECE 304a.

Referring now to FIG. 3C, the user 302 assigns the second ECE 304b to be onboarded to the first ECE 304a at step 340. The EO 314 responds by extending the ownership voucher 312b associated with the second ECE 304b to the first ECE 304a by signing the ownership voucher 312b with the public key 336 of the first ECE 304a at step 342, sending the extended ownership voucher 344 to be stored in the owner service 332 of the first ECE 304a at step 344. That is, for the scenario where user already has possession of the second ECE’s ownership voucher to be onboarded to the local owner before being shipped to the air-gapped site 324, the user 302 can assign the second ECE 304b to be onboarded to the designated local owner, which in this case, is the first ECE 304a. Additionally, the EO 314 will extend the second ECE ownership voucher 312b to the first ECE 340a, and send the second ECE ownership voucher 312b to the first ECE 304a.

Referring now to FIG. 3D, the first ECE 304a and second ECE 304b are shipped to the air-gapped site 324 at step 348. Once at the air-gapped site 324, the second ECE 304b can establish a connection and onboard to the first ECE 304a at step 350. Once onboarded, the second ECE 304b can now form an ECE cluster with the first ECE 304a and share any running workloads at step 352.

FIG. 3E illustrates the steps that may be taken to onboard yet another third ECE 304c to the air-gapped site 348 according to one embodiment of the present disclosure. Under this scenario where the user 302 purchased a new third ECE 304c to be added into an existing ECE cluster operating at an air-gapped site 348, the user 302 can still perform at least somewhat similar steps to assign the new third ECE 304c to onboard to the designated local owner, which in the present case, is the first ECE 304a.

As shown at step 356, the user 302 purchases the third ECE 304c, and imports the ownership voucher 312c into the EO 314 at step 358. The user 302 then assigns the third ECE 304c to onboard on the first ECE 304a at step 360. At step 362, the EO 314 extends the ownership voucher 312c, using public key 336, and at step 364, stores the extended ownership voucher 312c in an out-of-band storage device 366, such as a USB memory stick. Thereafter at step 368, the extended ownership voucher 370 can then be transferred out-of-band to the first ECE 304a. Once completed, the third ECE 304c can be shipped directly to air-gapped site 348 and onboarded to the first ECE 304a at step 372. At this point, the third ECE 304c will be able to join the existing ECE cluster with the first ECE 304a and second ECE 304b.

Although FIGS. 3A-3E describe an example FIDO device onboarding method that may be performed to onboard ECEs in an air-gapped environment, the features of the FIDO device onboarding method may be embodied in other specific forms without deviating from the spirit and scope of the present disclosure. For example, the FIDO device onboarding method may perform additional, fewer, or different operations than those described in the present examples. For another example, the FIDO device onboarding method may be performed in a sequence of steps different from that described above. As yet another example, certain steps of the FIDO device onboarding method may be performed by other components other than those described above.

Thus as described above, the FIDO device onboarding system and method provides a technique for onboarding ECEs conforming to a FIDO protocol in an air-gapped environment. The ECEs are onboarded using Secure Device Onboarding without the need of connection to an EO. In some cases, this may allow a more convenient way to scale or deploy new ECEs at the air-gapped environment without sacrificing its security. Embodiments of the present disclosure may provide certain advantages over conventional FIDO-based ECE implementations. For example, the FIDO device onboarding system 200 may reduce complexity and cost when deploying new additional ECEs at remote locations where connection to an EO is limited. Additionally, cost and carbon footprint may be reduced by eliminating or reducing the need for ECE re-shipment. The FIDO device onboarding system and method may also provide dynamic scaling of an ECE cluster where additional ECEs can securely join an existing ECE cluster without direct involvement and facilitation from the EO.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” when used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A FIDO device onboarding system comprising:
a first Edge Compute Endpoint (ECE) that conforms to a Fast ID Online (FIDO) Device Onboard (FDO) standard, the first ECE comprising a processor and a memory coupled to the processor, the memory having program instructions stored thereon that, upon execution, cause the first ECE to:
assign the first ECE to be a local owner in an air-gapped environment;
receive an extended ownership voucher associated with a second ECE, wherein the extended ownership voucher is signed by a public key of the first ECE; and
using the extended ownership voucher, onboard the second ECE to the first ECE.

2. The FIDO device onboarding system of claim 1, wherein the program instructions, upon execution, further cause the first ECE to receive the extended ownership voucher from an external to the air-gapped environment.

3. The FIDO device onboarding system of claim 2, wherein an original ownership voucher is used to generate the extended ownership voucher, and wherein the original ownership voucher is configured to be stored in the EO.

4. The FIDO device onboarding system of claim 1, wherein the program instructions, upon execution, further cause the first ECE to receive the extended ownership voucher from an EO prior to shipping the second ECE to the air-gapped environment.

5. The FIDO device onboarding system of claim 1, wherein the program instructions, upon execution, further cause the first ECE to receive the extended ownership voucher using an out-of-band storage device.

6. The FIDO device onboarding system of claim 1, wherein the program instructions, upon execution, further cause the first ECE to assign the first ECE to be the local owner:
execute a rendezvous (RV) service to perform an initial registration of the second ECE; and
execute an owner service to store the extended ownership voucher.

7. The FIDO device onboarding system of claim 1, wherein the program instructions, upon execution, further cause the first ECE to form a cluster with the second ECE after the second ECE has been onboarded.

8. A FIDO device onboarding method comprising:
assigning, using a first Edge Compute Endpoint (ECE) that conforms to a Fast ID Online (FIDO) Device Onboard (FDO) standard, the first ECE to be a local owner in an air-gapped environment;
receiving an extended ownership voucher associated with a second ECE, wherein the extended ownership voucher is signed by a public key of the first ECE; and
using the extended ownership voucher, onboarding the second ECE to the first ECE.

9. The FIDO device onboarding method of claim 8, further comprising receiving the extended ownership voucher from an Edge Orchestrator (EO) external to the air-gapped environment.

10. The FIDO device onboarding method of claim 9, further comprising generating, using an original ownership voucher, the extended ownership voucher, and wherein the original ownership voucher is stored in the EO.

11. The FIDO device onboarding method of claim 8, further comprising receiving the extended ownership voucher from an EO prior to shipping the second ECE to the air-gapped environment.

12. The FIDO device onboarding method of claim 8, further comprising receiving the extended ownership voucher using an out-of-band storage device.

13. The FIDO device onboarding method of claim 8, further comprising, to assign the first ECE to be the local owner:
executing a rendezvous (RV) service to perform an initial registration of the second ECE; and
executing an owner service to store the extended ownership voucher.

14. The FIDO device onboarding method of claim 8, further comprising forming a cluster with the second ECE after the second ECE has been onboarded.

15. A computer program product comprising a non-transitory computer readable storage medium having program instructions stored thereon that, upon execution by an Information Handling System (IHS), cause the IHS to:
assign, using a first Edge Compute Endpoint (ECE) that conforms to a Fast ID Online (FIDO) Device Onboard (FDO) standard, the first ECE to be a local owner in an air-gapped environment;
receive an extended ownership voucher associated with a second ECE, wherein the extended ownership voucher is signed by a public key of the first ECE; and
using the extended ownership voucher, onboard the second ECE to the first ECE.

16. The computer program product of claim 15, wherein the program instructions, upon execution, further cause the IHS to receive the extended ownership voucher from an Edge Orchestrator (EO) external to the air-gapped environment.

17. The computer program product of claim 16, wherein an original ownership voucher is used to generate the extended ownership voucher, and wherein the original ownership voucher is configured to be stored in the EO.

18. The computer program product of claim 15, wherein the program instructions, upon execution, further cause the IHS to receive the extended ownership voucher from an EO prior to shipping the second ECE to the air-gapped environment.

19. The computer program product of claim 15, wherein the program instructions, upon execution, further cause the IHS to receive the extended ownership voucher using an out-of-band storage device.

20. The computer program product of claim 15, wherein the program instructions, upon execution, further cause the IHS to assign the first ECE to be the local owner:
execute a rendezvous (RV) service to perform an initial registration of the second ECE; and
execute an owner service to store the extended ownership voucher.
